(19) United States
(12) Patent Application Publication
(10) Pub. No.: US 2004/0072001 A1
(43) Pub. Date: Apr. 15, 2004

(54) Packaging film in particular twist-wrapping film and method for production thereof

(76) Inventors: Markus Hamulski, Gronau (DE); Peter Schafer, Steinfurt (DE)

Correspondence Address: WILLIAM COLLARD, COLLARD & ROE, P.C., 1077 NORTHERN BOULEVARD, ROSLYN, NY, 11576, US

(21) Appl. No.: 10/467,109

(22) PCT Filed: Jan. 24, 2002
(86) PCT No.: PCT/EP02/00689

(30) Foreign Application Priority Data
Feb. 5, 2001 (DE) 101 05 125.5

(51) Int. Cl. B32B 27/00

(52) U.S. Cl. 428/515; 428/500

(57) ABSTRACT

A film comprising at least three layers, whereby the inner layer contains polyolefins and/or olefin co-polymers and, on both sides of the inner layer at least one further layer is provided containing a mixture of styrol-butadiene-styrol block co-polymers with styrol homo-polymers, a method for production thereof and the use thereof as a packaging film, in particular a twist-wrapping film.

The invention relates to films that are suitable as packaging materials, in particular twist-wrapping films that comprise at least three layers of polymer plastics, and a method for the production of such films.

A large number of films for packaging the most varied products is available in commerce. In the packing of sweets, such as candies and filled chocolates, twist-wrapping films are used, whereby these films are expected to have a good deadfold, i.e. a low rebound capacity, good rigidity, as well as transparency and brilliance.

Even today, however, approximately ⅓ of all twist-wrapping packaging for sweets is produced from wax paper. However, wax paper has the disadvantage that depending on the packaged goods, different amounts of the wax layer are transferred to the packaged goods. This in turn can have the result that the candies and filled chocolates become unsightly on their surface or that they even undergo a deterioration in their taste.

An alternative suitable for twist-wrapping is films on a cellophane basis. The advantageous properties of such films, such as tear resistance, transparency, and flavor seal, are, however, offset by their complicated and expensive production, as well as the rustle of the protective cellophane covering, which is often perceived to be annoying. PVC films, which, like cellophane, are expensive to produce, also possess a slight significance.

The less expensive printable polypropylene films, some of which are also strip-metallized, are an alternative, particularly in the area of twist films or candy twist-wrapping films, since it is possible to package candies at a speed of up to 1400 pieces per minute with these films. A film that can be used as an alternative in the twist-wrapping method is based on high-density polyethylene and is characterized by a high content of mineral fillers, so that it feels like paper. The processing properties of this film are very similar to those of wax paper.

It was the task of the present invention to make available an improved film that is particularly suitable as a packaging material and is particularly used as a twist-wrapping film. The improved film was supposed to be superior to the known packaging films not only with regard to its very good twisting properties, great rigidity, as well as good cuttability or punchability, but also with regard to its expandability, impact penetration strength, and economic efficiency, and was supposed to possess excellent barrier functions, along with very good transparency and high gloss.

It was possible to accomplish this task with a packaging film comprising at least three layers, whereby the inner layer contains polyolefins and/or olefin copolymers and, on both sides of the inner layer, at least one further layer is provided containing a mixture of styrene-butadiene-styrene block copolymers with polystyrene homopolymers.

The total thickness of the film is not subject to any particular restrictions, but rather is dependent on the type of the packaged goods as well as economic considerations, but usually lies in the range of 10-50 μm, particularly 15-40 μm, and particularly preferably in the range of 20-25 μm.

The thickness ratio of the inner layer to the thicknesses of the two layers adjacent to it is also not subject to any fundamental restrictions. However, it has proven to be advantageous if the ratio of the thickness of the layer present on each side of the inner layer to the thickness of the inner layer is 1:1 to 1:6. A ratio of 1:2 to 1:4 is particularly preferred.

It is preferred that the inner layer essentially contains polyolefins and/or olefin copolymers, i.e. essentially consists of them. Thus, the core can also consist entirely of polyolefins and/or olefin copolymers. Polymers based on ethylene and propylene, as well as mixtures of them with one another or with other olefins, such as butene, have proven to be particularly suitable. The use of such polyolefins or olefin copolymers particularly leads to an improvement in the stretching capacity, impact penetration strength, and water vapor barrier properties, i.e. protection against drying out and weight loss, in the case of moist packaged goods, or protection against moisture absorption, in the case of dry packaged goods, as well as protection against mold formation. In addition, the use of the polyolefins or olefin copolymers increases the economic efficiency of the product.

By means of the use of mixtures of styrene-butadiene-styrene block copolymers with polystyrene homopolymers, the film is given very good twist-wrapping properties, great rigidity, and easier cuttability or punchability.

If transparency is not desired, the films according to the invention can also be dyed with food-compatible pigments, such as titanium dioxide, in order to obtain a white film, for example. On the basis of the structure of the film, good printability is also guaranteed. Another coating of these films, for example in order to equip them with further barrier properties, is also possible. In this connection, metallization, for example aluminum vapor deposition, a coating or vapor-deposition of inorganic materials such as SiOₓ or Al₂O₃, for example, is possible. In addition, a coating by means of plasma polymerization or with poly(vinylidene chloride) or organic inorganic hybrid polymers is possible.

The present invention also makes a method for the production of the film according to the invention available. Thus, it was found that co-extrusion on conventional extrusion systems, particularly blown film extrusion systems and broad-slit die extrusion systems is advantageous. In particular, it has proven to be advantageous to produce the films with a high proportion of polyethylene in the inner layer by means of blown film extrusion, while films on a polypropylene basis are advantageously processed on broad-slit die extrusion systems.

The present invention also relates to the use of the films according to the invention, particularly their use as packaging material, and very particularly as a twist-wrapping film. Since the low rebound capacity that is necessary for twist-wrapping represents only one of the advantages of the film according to the invention, their use is not restricted to the twist-wrapping method, but rather also allows use in other areas in which the advantageous properties are desired.

The examples given below are intended to serve to illustrate the invention (Note: Unless otherwise defined, the % information relates to percent by weight).

### EXAMPLE 1

A three-layer packaging film is extruded on a blown film extrusion system (die diameter 315 mm). The inner layer consists of a polyethylene copolymer with butene, whereby the density of the polyethylene corresponds to 0.918 to 0.940 g/cm³ and the melt index lies between 0.7 and 4 g/10 min. at 190° C. and 2.16 kg. The two layers adjacent to the inner layer are composed of 10 to 80 wt.-% styrene-butadiene-styrene block copolymer and 90 to 20 wt.-% polystyrene. In addition, an anti-static agent is used.

The total thickness of the film amounts to 25 μm, whereby the thickness of the two outer layers amounts to 5 μm, in each instance, and that of the inner layer amounts to 15 μm. Use of the film: Twist-wrapping film for caramel candies.

### EXAMPLE 2

A three-layer packaging film is co-extruded on a broad-slit die co-extrusion system. A polypropylene random copolymer with ethylene is used for the inner layer (density of the polypropylene is 0.902 g/cm³ and the melt index is 6 g/10 min. at 230° C. and 2.16 kg). The two layers adjacent to the inner layer are composed as described in Example 1.

The total thickness of the film amounts to 20 μm.

### COMPARISON EXAMPLE 1

A three-layer film is co-extruded on a broad-slit die co-extrusion system as described in Example 2. The inner layer consists of a polypropylene random copolymer as described in Example 2. The layers adjacent to the inner layer are extruded from a polypropylene homopolymer having a density of 0.910 g/cm³, with a melt index of 10 g/10 min. at 230° C. and 2.16 kg.

The total thickness of the film amounts to 20 μm.

Assessment of the Examples and the Comparison Example

While the films of Examples 1 and 2 possess the excellent properties according to the invention, and are particularly characterized by their excellent optical properties, their good processability on conventional twist-wrapping machines, and very good protection for the wrapped product, the film obtained in Comparison Example 1 is only suitable as a twist-wrapping film with restrictions, because of its lack of rigidity and its insufficiently good cutting properties.

1. Packaging film, in particular twist-wrapping film, comprising at least three layers of polymer plastics, characterized in that
a) the inner layer contains polyolefins and/or olefin copolymers,
b) and that, on both sides of the inner layer, at least one further layer is provided containing a mixture of styrene-butadiene-styrene block copolymers with polystyrene homopolymers.

2. Packaging film according to claim 1, characterized in that it possesses a thickness of 15-50 μm.

3. Packaging film according to claim 2, characterized in that it possesses a thickness of 20-25 μm.

4. Packaging film according to one or more of claims 1 to 3, characterized in that the thickness ratio of the layer present on each side of the inner layer to the thickness of the inner layer is 1:1 to 1:6.

5. Packaging film according to claim 4, characterized in that the ratio is 1:2 to 1:4.

6. Packaging film according to one or more of claims 1 to 5, characterized in that the polyolefin is a polyethylene, polypropylene, polyethylene copolymer or polypropylene copolymer.

7. Packaging film according to one or more of claims 1 to 6, characterized in that the film layers additionally contain pigments.

8. Packaging film according to one or more of claims 1 to 7, characterized in that an additional layer or several additional layers are applied to one or both of the layers adjacent to the inner layer.

9. Packaging film according to claim 8, characterized in that the additional layer or the additional layers have been obtained by means of vapor-deposition or coating with metals, inorganic materials, polyvinylidene chloride, or organic-inorganic hybrid copolymers or by means of plasma polymerization.

10. Method for the production of a packaging film according to one or more of claims 1 to 10, characterized in that the inner layer and the two layers adjacent to the inner layer are co-extruded.

11. Method for the production of a packaging film according to claim 11 [sic], characterized in that the co-extrusion is a blown film co-extrusion or broad-slit die co-extrusion.

12. Method for the production of a film according to claim 11, characterized in that the co-extrusion takes place by means of blown film co-extrusion in the case of the use of polyethylene or polyethylene copolymers as the inner layer.

13. Method for the production of a film according to claim 11, characterized in that the co-extrusion takes place by means of broad-slit die co-extrusion in the case of the use of polypropylene or polypropylene copolymers as the inner layer.
